(19) United States
(12) Patent Application Publication
(10) Pub. No.: US 2026/0191363 A1
(43) Pub. Date: Jul. 9, 2026

(54) MODULAR COOKING SYSTEM

(71) Applicant: Zaid Kurdi, Laval (CA)

(72) Inventor: Zaid Kurdi, Laval (CA)

(21) Appl. No.: 19/014,925

(22) Filed: Jan. 9, 2025

(51) Int. Cl. A47J 44/00; A47J 27/122; A47J 36/32; B25J 5/04; B25J 11/00

(52) U.S. Cl. CPC A47J 44/00; A47J 27/122; A47J 36/321; B25J 5/04; B25J 11/0045; A47J 2201/00

(57) ABSTRACT

A modular cooking system for cooking food using interchangeable cooking modules includes a main body which defines a plurality of bays, each of which is open on a front side of the main body. Each one of a plurality of front cooking modules is receivable into an associated bay of the plurality of bays. Each front cooking module is configured to perform an associated cooking function. The front cooking modules may include, for example, a conventional oven, a convection oven, a microwave, a sous vide device, a pressure cooker, an air fryer, a deep fat fryer, a stovetop-style burner, or the like.

### (b) CROSS-REFERENCE TO RELATED APPLICATIONS

Not Applicable.

### (C) STATEMENT REGARDING FEDERALLY SPONSORED RESEARCH OR DEVELOPMENT

Not Applicable.

### (d) THE NAMES OF THE PARTIES TO A JOINT RESEARCH AGREEMENT

Not Applicable.

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable.

### (f) STATEMENT REGARDING PRIOR DISCLOSURES BY THE INVENTOR OR JOINT INVENTOR

Not Applicable.

### (g) BACKGROUND OF THE INVENTION

### (1) Field of the Invention

The disclosure relates to cooking apparatuses and more particularly pertains to a new cooking apparatus for cooking food using interchangeable cooking modules.

### (2) Description of Related Art INCLUDING INFORMATION DISCLOSED UNDER 37 CFR 1.97 and 1.98.

The prior art relates to various cooking apparatuses which combine various cooking mechanisms into a single appliance. Some such cooking apparatuses have components which may be manufactured in a modular fashion such that different cooking mechanisms may be used in different final products of the manufacturing process. However, the prior art fails to describe such an apparatus which includes cooking modules which may be interchangeably mounted in a main body. The prior art also fails to disclose such a device which may prepare food for cooking and move the food from a preparation area to one of the interchangeable cooking modules.

### (h) BRIEF SUMMARY OF THE INVENTION

An embodiment of the disclosure meets the needs presented above by generally comprising a main body which defines a plurality of bays, each of which is open on a front side of the main body. Each one of a plurality of front cooking modules is receivable into an associated bay of the plurality of bays. Each front cooking module is configured to perform an associated cooking function. The front cooking modules may include, for example, a conventional oven, a convection oven, a microwave, a sous vide device, a pressure cooker, an air fryer, a deep fat fryer, a stovetop-style burner, or the like.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a modular cooking system according to an embodiment of the disclosure.

FIG. 2 is a side view of an embodiment of the disclosure.

FIG. 3 is a top view of an embodiment of the disclosure.

FIG. 4 is a perspective exploded view of an embodiment of the disclosure.

FIG. 5 is a front view of a front cooking module of an embodiment of the disclosure.

FIG. 6 is a rear view of a front cooking module of an embodiment of the disclosure.

FIG. 7 is a side view of a front cooking module of an embodiment of the disclosure.

FIG. 8 is a bottom view of a front cooking module of an embodiment of the disclosure.

FIG. 9 is a top view of a plurality of cooktop modules of an embodiment of the disclosure.

FIG. 10 is a bottom view of a plurality of cooktop modules of an embodiment of the disclosure.

FIG. 11 is a detail perspective view of a chopping module of an embodiment of the disclosure taken from Window 11 in FIG. 3.

FIG. 12 is a detail perspective view of a seasoning dispenser module of an embodiment of the disclosure taken from Window 11 in FIG. 3.

FIG. 13 is a block diagram of an embodiment of the disclosure.

### (j) DETAILED DESCRIPTION OF THE INVENTION

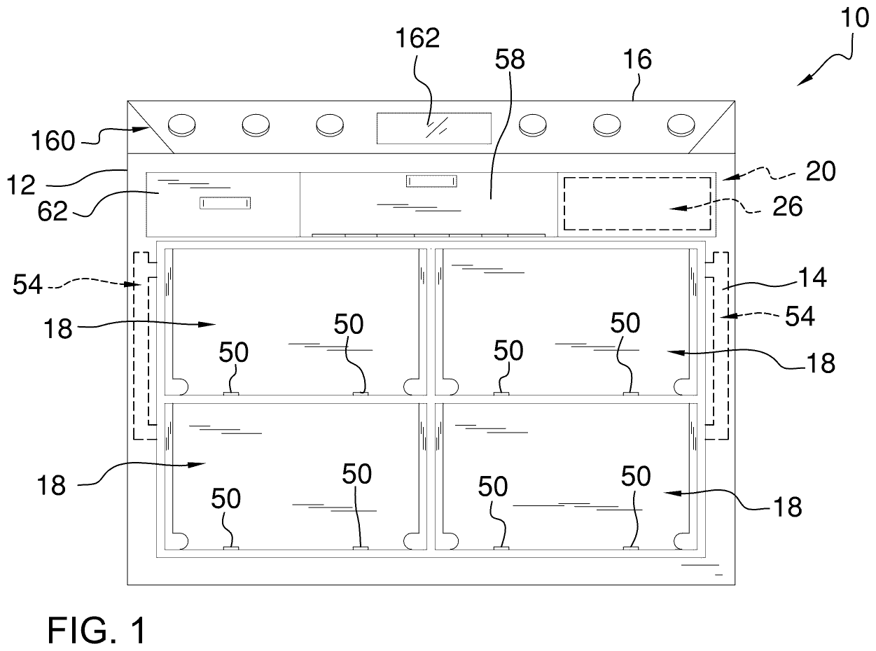

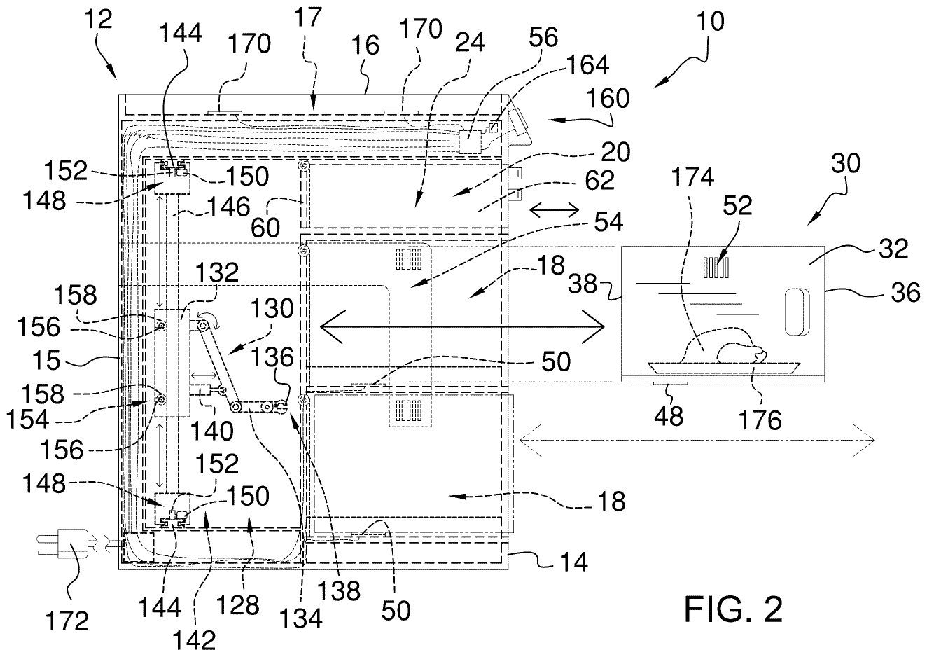

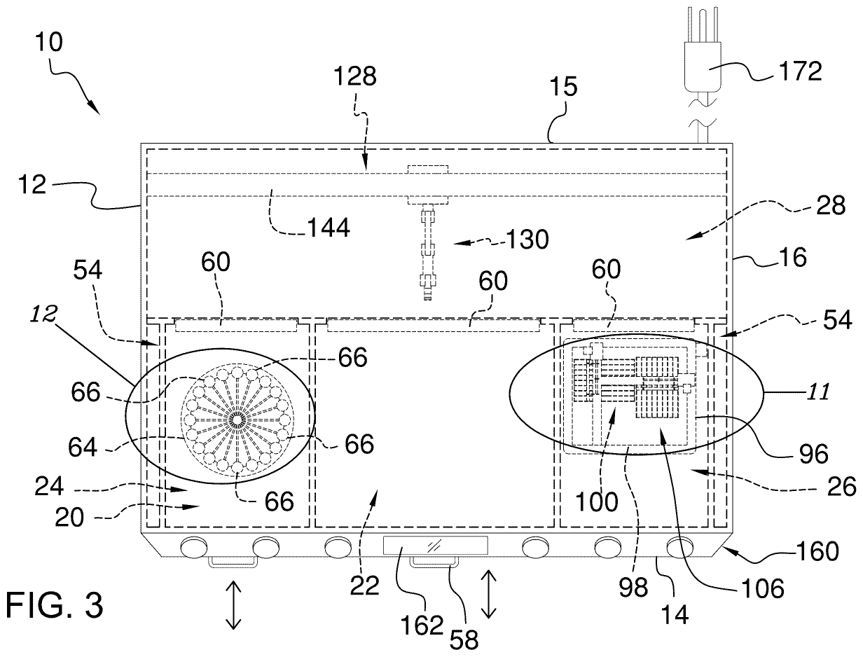

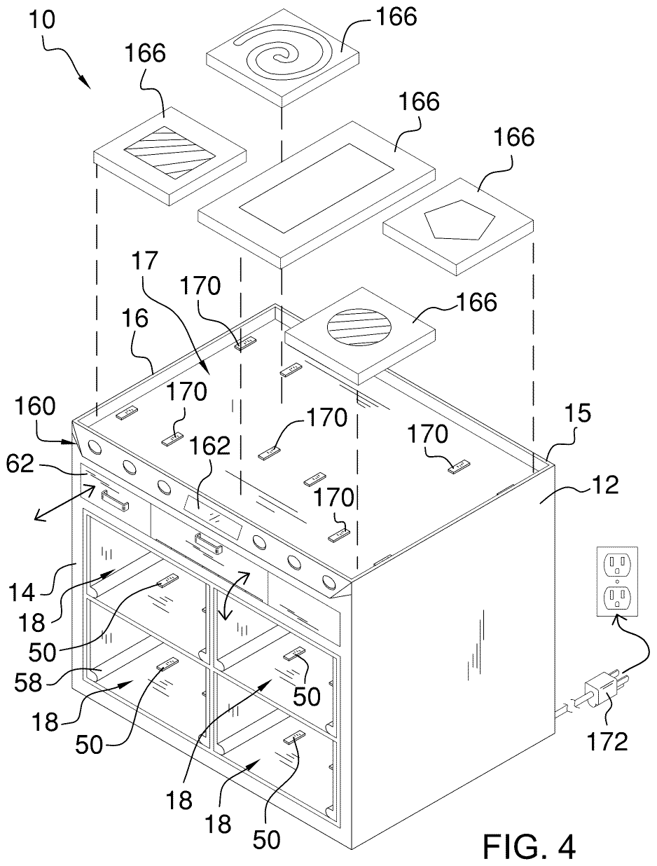

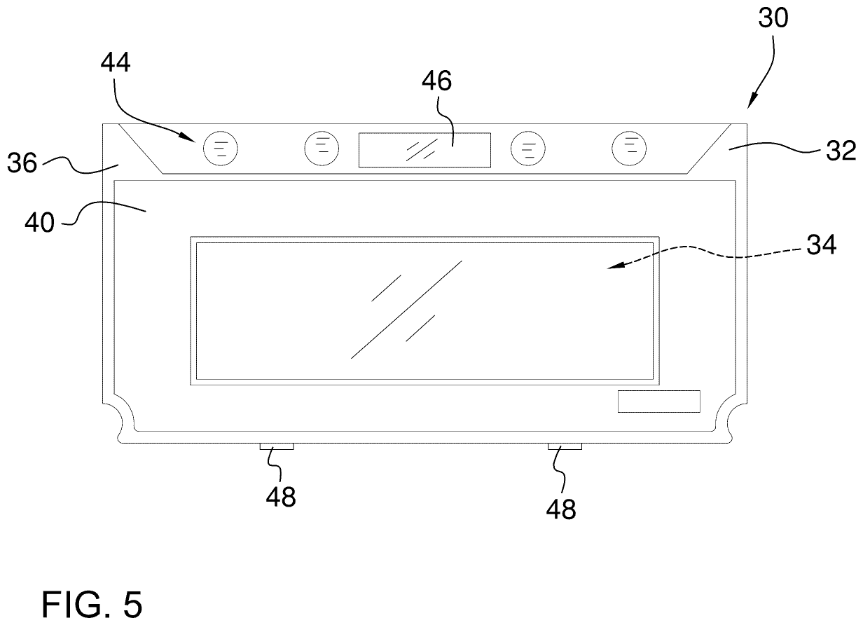

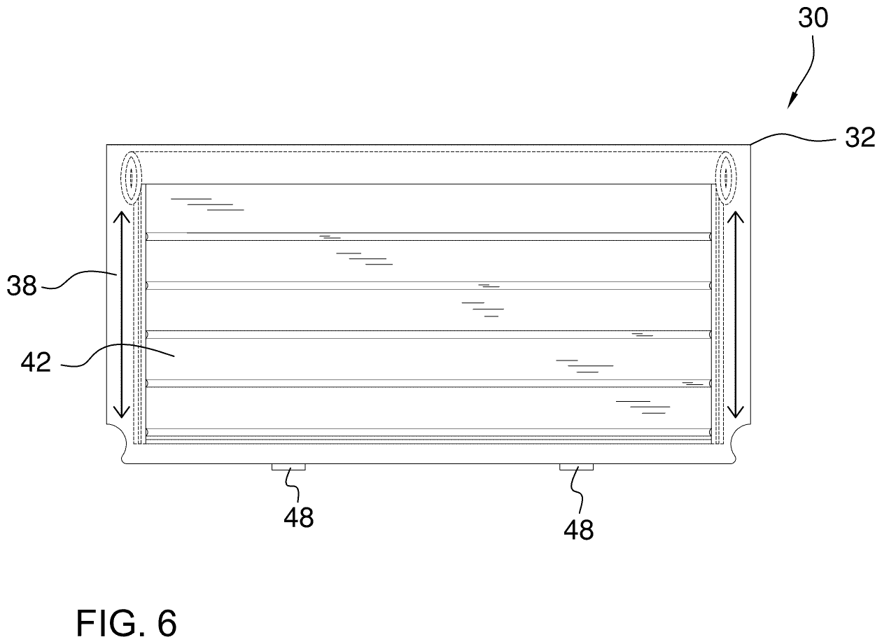

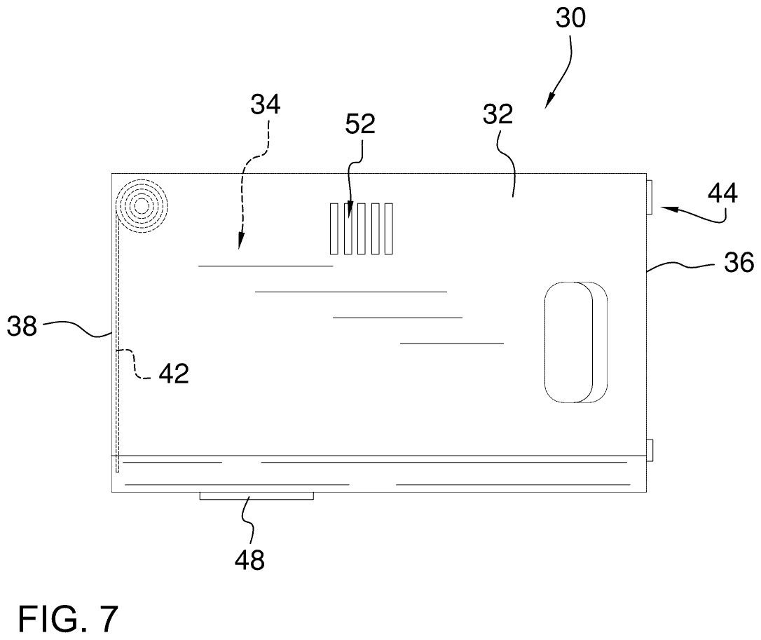

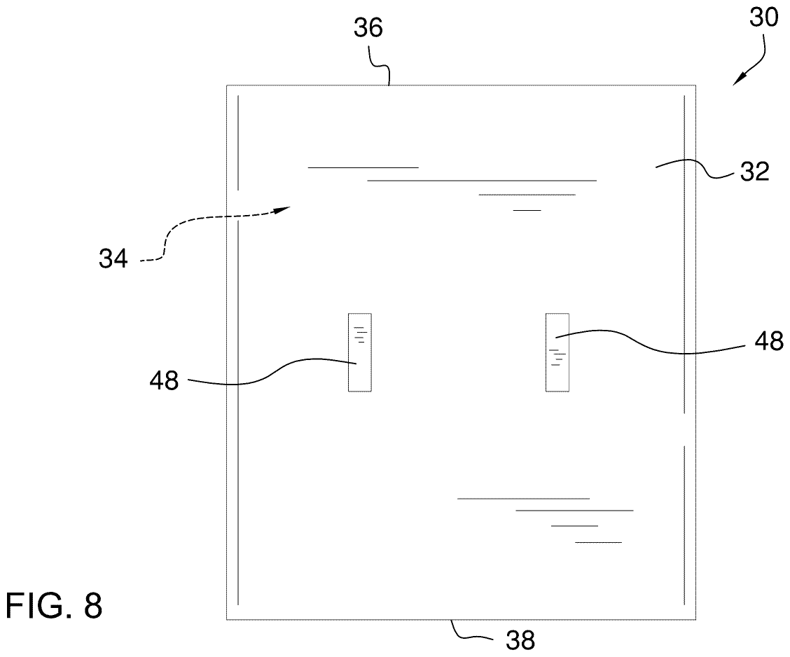

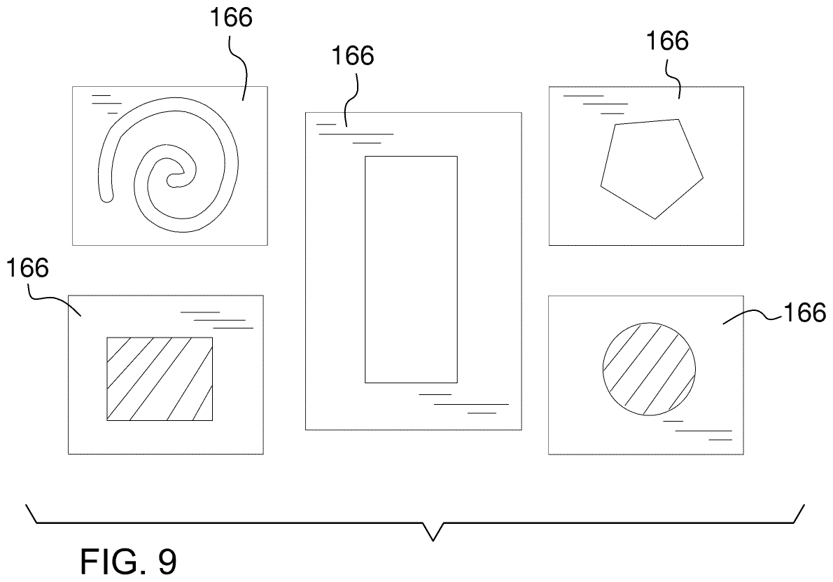

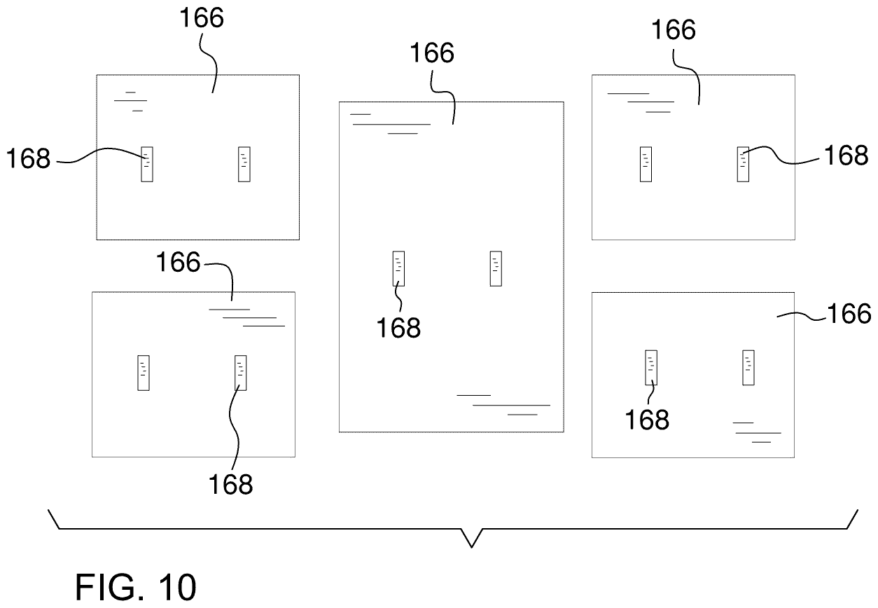

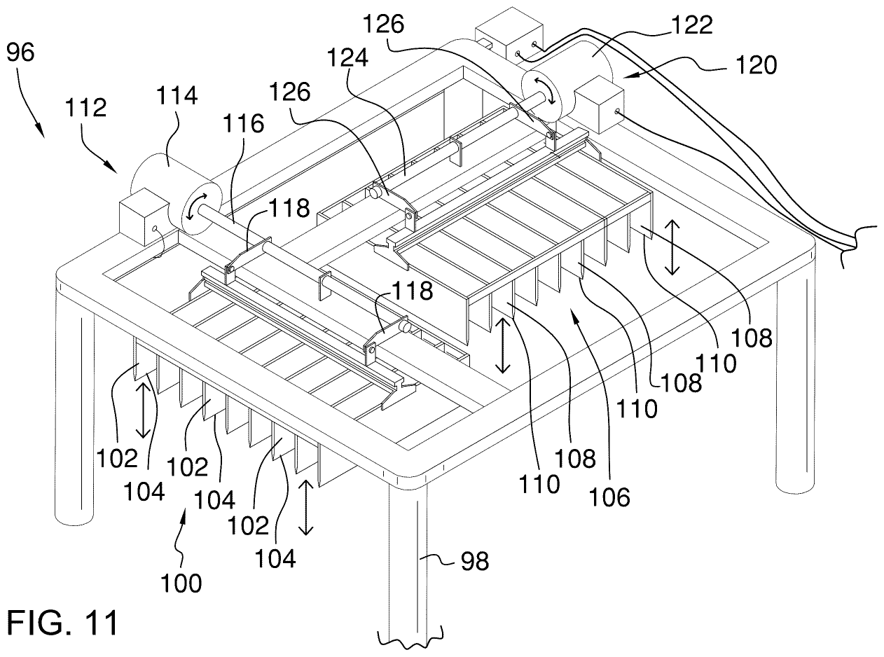

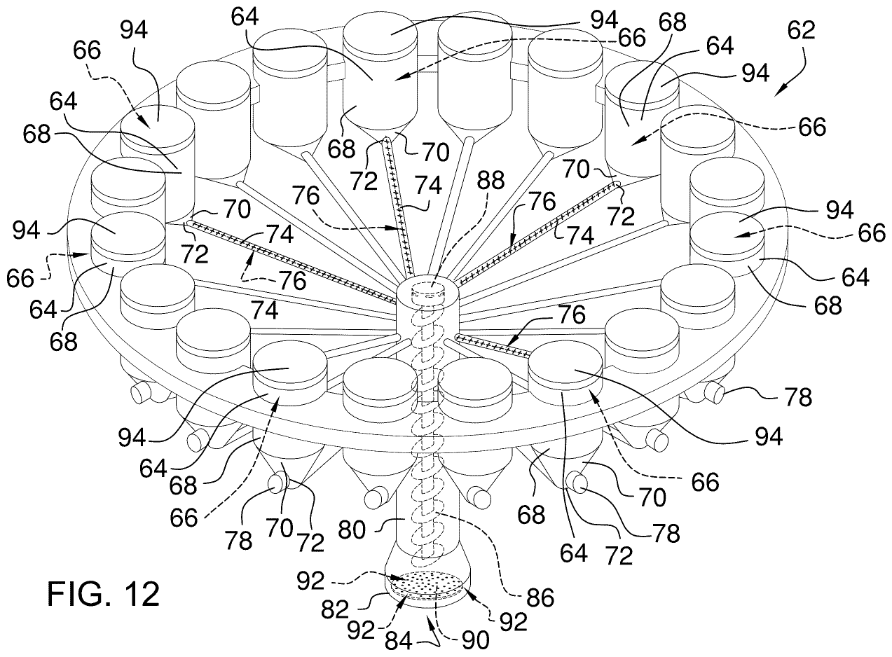

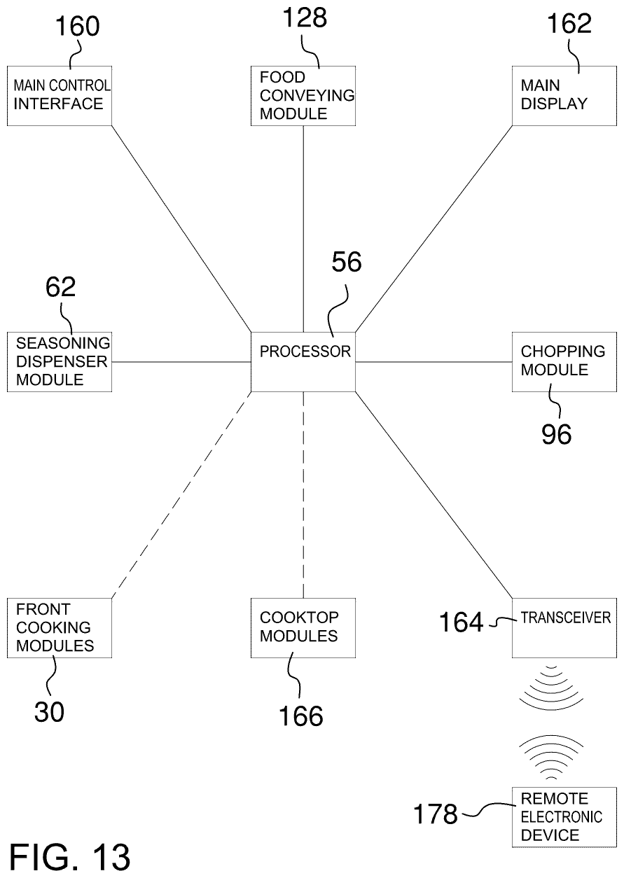

With reference now to the drawings, and in particular to FIGS. 1 through 13 thereof, a new cooking apparatus embodying the principles and concepts of an embodiment of the disclosure and generally designated by the reference numeral 10 will be described.

As best illustrated in FIGS. 1 through 13, the modular cooking system 10 generally comprises a main body 12 which defines a plurality of bays 18, each of which is open on a front side 14 of the main body 12. The main body 12 defines a food preparation compartment 20 therein which is separated from the plurality of bays 18. The food preparation compartment 20 includes a food loading section 22, a seasoning section 24, and a chopping section 26, wherein the food loading section 22 is positioned between and is in fluid communication with the seasoning section 24 and the chopping section 26. The main body 12 further defines a conveying space 28 which is positioned between the plurality of bays 18 and a back side 15 of the main body 12. The conveying space 28 is also positioned between the food preparation compartment 20 and the back side 15 of the main body 12. The main body 12 defines a recess 17 in a top side 16 of the body.

Each one of a plurality of front cooking modules 30 is receivable into an associated bay 18 of the plurality of bays 18. Each front cooking module 30 is configured to perform an associated cooking function. For example, one or more front cooking modules 30 may include a conventional oven, a convection oven, a microwave, a sous vide device, a pressure cooker, an air fryer, a deep fat fryer, a stovetop-style burner, or the like sufficient for performing a cooking function corresponding to the respective cooking mechanisms of the front cooking modules 30. Each front cooking module 30 comprises an enclosure 32 which defines an interior volume 34 therein. The enclosure 32 is complementary in shape to the associated bay 18. Each front cooking module 30 further comprises a front door 40 mounted on a front wall 36 of the enclosure 32 and a rear door 42 mounted on a rear wall 38 of the enclosure 32. Each of the front door 40 and the rear door 42 is movable to selectively access the interior volume 34 of the enclosure 32 from outside the enclosure 32. The front door 40 and the rear door 42 may be of varying styles, such as a simple pivoting door, a roll-up door similar to the type used for garage doors, a French door, a sliding door, or the like. For example, the Figures depict the rear door 42 of each front cooking module 30 as a roll-up door which may be beneficial in preventing interference with food placed in the front cooking module 30 and other components. A French door style may also be used to minimize the space through which a pivoting door segment swings into the interior volume 34.

Each front cooking module 30 further comprises a front module control interface 44 and a front module display 46 which are mounted on the front wall 36 of the enclosure 32. The front module control interface 44 is configured to operate the front cooking module 30. Each front cooking module 30 also has a set of front module electrical contacts 48 mounted to an exterior of the enclosure 32 which electrically couple to a corresponding set of bay electrical contacts 50 which are mounted in the associated bay 18. Each front cooking module 30 defines a vent 52 which extends into the front cooking module 30 to the interior volume 34. The vent 52 of each front cooking module 30 aligns with ductwork 54 defined by the main body 12 such that heat or pressure may be released away from the main body 12 when desirable for operation of the respective front cooking module 30. Ventilation doors may be implemented to selectively open these vents 52 and ventilation door actuators may further be implemented to move the ventilation doors accordingly.

A processor 56 is mounted in the main body 12. The processor 56 electrically couples to the front cooking modules 30 via their electrical contacts and the corresponding bay electrical contacts 50. In some embodiments, the processor 56 may operate the front cooking modules 30 via wireless signals, or the front cooking modules 30 may have independent processing circuitry.

A food loading door 58 mounted to the front side 14 of the main body 12 and is movable to selectively access the food loading section 22 of the food preparation compartment 20. A plurality of food preparation access doors 60 is mounted to the main body 12 between the food preparation compartment 20 and the conveying space 28. Each food preparation access door 60 is movable to selectively access the food preparation compartment 20 from the conveying space 28. Each food preparation access door 60 of the plurality of food preparation access doors 60 is positioned adjacent to a respective one of the food loading section 22, the seasoning section 24, and the chopping section 26. In some embodiments, a single access door may be used which extends across each of the food loading section 22, the seasoning section 24, and the chopping section 26. In some embodiments, the single access door may only be positioned to extend across the food loading section 22.

A seasoning dispenser module 62 mounted in the seasoning section 24 of the food preparation compartment 20. The seasoning dispenser module 62 comprises a plurality of seasoning containers 64 which may be used to contain various seasonings, including herbs, spices, minerals, or other flavorings. Dispensing mechanisms are implemented to dispense the contents of the seasoning containers 64. In the embodiment shown in the Figures, each seasoning container 64 defines an interior space 66 therein. Each seasoning container 64 comprises a perimeter wall 68 and a funnel 70, wherein the funnel 70 is coupled to and extends downwardly from the perimeter wall 68.

The seasoning dispenser module 62 further includes a plurality of seasoning tubes 74, a plurality of seasoning augers 76, and a plurality of seasoning auger motors 78. Each seasoning tube 74 is in fluid communication with an associated seasoning container 64 at an outlet end 72 of the funnel 70 of the associated seasoning container 64. Each seasoning auger 76 is positioned in an associated seasoning tube 74 of the plurality of seasoning tubes 74 and extends along the associated seasoning tube 74. Each seasoning auger motor 78 is operatively coupled to an associated seasoning auger 76 of the plurality of seasoning augers 76. Each seasoning tube 74 extends from the associated seasoning container 64 to a dispensing tube 80 which extends vertically with respect to the main body 12 and defines an outlet 84 at a bottom end 82 thereof. A dispensing auger 86 is mounted in and extends along the dispensing tube 80, and a dispensing auger motor 88 is operatively coupled to the dispensing auger 86. A screen 90 is mounted in the dispensing tube 80 adjacent to the outlet 84 and defines a plurality of apertures 92 which extend therethrough. The seasoning dispenser module 62 also includes lids 94 which are positionable to cover the seasoning containers 64. The seasoning dispenser module 62 is removable from the food preparation compartment 20 through the front side 14 of the main body 12 such that the lids 94 may be moved to add contents to the seasoning containers 64.

In other embodiments, other dispensing mechanisms may be used to dispense contents of the seasoning containers 64. For example, vibration motors may be used to shake one or more shaker containers to dispense contents through holes in a base of the shaker container. In other embodiments, conveyor belts, dosing cups, or the like may be used to dose and dispense the contents of the seasoning containers 64.

A chopping module 96 mounted in the chopping section 26 of the food preparation compartment 20. The chopping module 96 comprises a support frame 98, a first chopping member 100, and a second chopping member 106. The first chopping member 100 and the second chopping member 106 are movably mounted to the support frame 98 such that cutting edges may be urged against food placed in the chopping section 26. The first chopping member 100 comprises a plurality of first blades 102 and is movable alternately upwardly and downwardly with respect to the main body 12. Each first blade 102 has a first cutting edge 104 facing downwardly with respect to the main body 12. Each first blade 102 extends laterally with respect to the main body 12, and the first blades 102 are evenly spaced from and oriented parallel to each other. The second chopping member 106 comprises a plurality of second blades 108 and is movable alternately upwardly and downwardly with respect to the main body 12. Each second blade 108 has a second cutting edge 110 facing downwardly with respect to the main body 12. Each second blade 108 extends laterally with respect to the main body 12, and the second blades 108 are evenly spaced from and oriented parallel to each other.

A first chopping drive 112 is operatively coupled to the first chopping member 100 and a second chopping drive 120 is operatively coupled to the second chopping member 106. The first chopping drive 112 comprises a first chopping motor 114 and a pair of first lever arms 118, wherein the first lever arms 118 are coupled to and extend outwardly from an output shaft 116 of the first chopping motor 114. The first chopping member 100 is pivotably coupled to and hangs from the pair of first lever arms 118 opposite the output shaft 116 of the first chopping motor 114. The second chopping drive 120 comprises a second chopping motor 122 and a pair of second lever arms 126, wherein the second lever arms 126 are coupled to and extend outwardly from an output shaft 124 of the second chopping motor 122. The second chopping member 106 is pivotably coupled to and hangs from the pair of second lever arms 126 opposite the output shaft 124 of the second chopping motor 122. In other embodiments, the first chopping drive 112 and the second chopping drive 120 may comprise linear actuators or any other suitable reciprocating drive mechanism.

A food conveying module 128 is mounted in the main body 12 and is configured to move a food item 174 among the plurality of bays 18 of the main body 12 and the food loading section 22, the seasoning section 24, and the chopping section 26 of the food preparation compartment 20 of the main body 12. The food conveying module 128 comprises a robotic arm 130 mounted in the conveying space 28 of the main body 12 and a gantry 142 mounted in the conveying space 28 of the main body 12. The gantry 142 is configured to move the robotic arm 130 vertically and laterally with respect to the main body 12.

The robotic arm 130 comprises a base 132, an arm segment 134, and a linear actuator 140. The arm segment 134 is pivotably coupled to the base 132 and is movable alternately forward and rearward of the base 132 with respect to the main body 12. The arm segment 134 defines a notch 138 in a distal end 136 thereof with respect to the main body 12 which is configured to receive a tray 176 holding the food item 174. The linear actuator 140 is coupled to and extends between the base 132 and the arm segment 134. The linear actuator 140 is operable to pivot the robotic arm 130 with respect to the base 132. In other embodiments, various other suitable configurations of robotic arm 130 may be used. In some embodiments, the robotic arm 130 may include a grasper, a magnetic engagement member, a clamp, or the like for grabbing the tray 176.

The gantry 142 comprises a pair of horizontal rails 144 mounted to the main body 12 and extending laterally through the conveying space 28. The horizontal rails 144 are spaced from each other vertically with respect to the main body 12. A vertical rail 146 is movably mounted onto the pair of horizontal rails 144, and the base 132 of the robotic arm 130 is movably mounted to the vertical rail 146. A pair of horizontal drives 148 is mounted to the vertical rail 146, wherein each horizontal drive 148 is engaged with a respective horizontal rail 144 of the pair of horizontal rails 144 to move the vertical rail 146 along the pair of horizontal rails 144. Each horizontal drive 148 comprises a horizontal motor 150 and a horizontal drive wheel 152, wherein the horizontal motor 150 is operatively coupled to the horizontal drive wheel 152 and the horizontal drive wheel 152 is movably mounted on the respective horizontal rail 144. A vertical drive 154 is mounted to the base 132 of the robotic arm 130. The vertical drive 154 comprises a pair of vertical motors 156 and a pair of vertical drive wheels 158, wherein each vertical motor 156 is operatively coupled to a respective vertical drive wheel 158 of the pair of vertical drive wheels 158, and the pair of vertical drive wheels 158 is movably mounted on the vertical rail 146.

The food conveying module 128 may also comprise a conveyor belt or a platform which is slidable between the food loading section 22, the seasoning section 24, and the chopping section 26 of the food preparation compartment 20. Other suitable conveyor mechanisms may also be used.

The processor 56 is also operatively coupled to the seasoning dispenser module 62, the chopping module 96, and the food conveying module 128. A main control interface 160 is mounted to the main body 12 and is operatively coupled to the processor 56. A main display 162 is mounted to the main body 12 and is operably coupled to the processor 56. A transceiver 164 is operably coupled to the processor 56 such that the processor 56 is configured to communicate with a remote electronic device 178 via the transceiver 164. The remote electronic device 178 may be a smartphone, a tablet, a computer, or the like, and may communicate with the transceiver 164 via any suitable wireless communication network such as one following a BLUETOOTH or WI-FI protocol.

The remote electronic device 178 may include an application which may be used to send control signals to the processor 56. For example, the remote electronic device 178 may access a preset program which is included in the memory of the remote electronic device 178 as part of the application, available from an external source, or which is made by a user using the application. The preset program may be transmitted to the processor 56 via the transceiver 164 and be read by the processor 56, which follows the preset program to prepare and cook food according to the preset program.

Data may also be transmitted to the remote electronic device 178 such as status information about the front cooking modules 30, including temperature and pressure data. Data may also be displayed on the main display 162 or the front module display 46 of one of the front cooking modules 30.

Each one of a plurality of cooktop modules 166 is positionable in the recess 17 of the main body 12. Each cooktop module 166 comprises a pair of cooktop electrical contacts 170 which is positioned to electrically couple the cooktop module 166 to the processor 56 via an associated pair of top electrical contacts 170 of a plurality of top electrical contacts 170 mounted in the recess 17 of the main body 12. In other embodiments, the cooktop modules 166 may be controlled by the processor 56 via wireless signals or may have alternative processing circuitry and control interfaces. Each cooktop module 166 is configured to perform an associated cooktop cooking function. For example, the cooktop modules 166 may include various stovetop cooking elements such as gas burners, electrical heating elements, induction heating elements, or the like. In some embodiments, the cooktop modules 166 may include pressure cookers, air fryers, deep fat fryers, or the like. The cooktop modules 166 thus perform cooking functions corresponding to their respective cooking mechanisms.

Electrical power is supplied to the processor 56, the front cooking modules 30, the cooktop modules 166, the seasoning dispenser module 62, the chopping module 96, and the food conveying module 128 by an external power source via an electrical cord 172. In other embodiments, one or more power supplies such as batteries may be used to power these components.

In use, one or more front cooking modules 30 or cooktop modules 166 may be mounted to the main body 12. The food item 174 may, for example, be placed in a pan on a selected one of the cooktop modules 166, then the selected cooktop module 166 may be controlled via the main control interface 160 or the remote electronic device 178.

The food item 174 also may be placed on the tray 176 and inserted into the food loading section 22 of the food preparation compartment 20 via the front loading door. The food conveying module 128 may then be used to move the tray 176 to the seasoning section 24 where the food item 174 is seasoned by the seasoning dispenser module 62. Then the food conveying module 128 may move the tray 176 to the chopping section 26 where the food item 174 is cut via the chopping module 96. Then the food item 174 may be moved via the food conveying module 128 to a selected one of the front cooking modules 30 where the associated cooking function is performed on the food item 174.

Some embodiments of the modular cooking system 10 may be constructed without, for example, the food preparation compartment 20, the contents of the food preparation compartment 20, and the food conveying module 128. Additionally, some embodiments may forgo these elements but have appropriate mounting brackets or other attachment devices for adding these elements at a later stage.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A modular cooking system comprising:
a main body which defines a plurality of bays, each bay of the plurality of bays being open on a front side of the main body; and
a plurality of front cooking modules, each front cooking module of the plurality of front cooking modules being receivable into an associated bay of the plurality of bays, each front cooking module of the plurality of front cooking modules being configured to perform an associated cooking function.

2. The modular cooking system of claim 1, wherein each front cooking module of the plurality of front cooking modules comprises:
an enclosure defining an interior volume therein, the enclosure being complementary in shape to the associated bay of the plurality of bays; and
a front door mounted on a front wall of the enclosure, the front door being movable to selectively access the interior volume of the enclosure from outside the enclosure.

3. The modular cooking system of claim 2, wherein each front cooking module of the plurality of cooking modules further comprises:
a rear door mounted on a rear wall of the enclosure, the rear door being movable to selectively access the interior volume of the enclosure from outside the enclosure.

4. The modular cooking system of claim 2, wherein each front cooking module of the plurality of cooking modules further comprises:
a front module control interface mounted on the front wall of the enclosure, the front module control interface being configured to operate the front cooking module; and
a front module display mounted on the front wall of the enclosure.

5. The modular cooking system of claim 1, wherein:
the main body defines a food preparation compartment therein, the food preparation compartment including a food loading section, the main body defining a conveying space positioned between the plurality of bays and a back side of the main body, the conveying space being positioned between the food preparation compartment and the back side of the main body; and
further comprising:
a food loading door mounted to the front side of the main body, the food loading door being movable to selectively access the food loading section of the food preparation compartment; and
a food conveying module mounted in the main body, the food conveying module being configured to move a food item among the plurality of bays of the main body and the food loading section of the food preparation compartment.

6. The modular cooking system of claim 5, wherein:
the food preparation compartment further comprises a seasoning section, the seasoning section being in fluid communication with the food loading section; and
further comprising a seasoning dispenser module mounted in the seasoning section of the food preparation compartment, the seasoning dispenser module being configured to add seasoning to the food item when the food item is positioned in the seasoning section of the food preparation compartment.

7. The modular cooking system of claim 6, wherein the seasoning dispenser module comprises:
a plurality of seasoning containers, each seasoning container of the plurality of seasoning containers defining an interior space therein;
a plurality of seasoning tubes, each seasoning tube of the plurality of seasoning tubes being in fluid communication with an associated seasoning container of the plurality of seasoning containers;
a plurality of seasoning augers, each seasoning auger of the plurality of seasoning augers being positioned in an associated seasoning tube of the plurality of seasoning tubes, each seasoning auger of the plurality of seasoning augers extending along the associated seasoning tube; and
a plurality of seasoning auger motors, each seasoning auger motor of the plurality of seasoning auger motors being operatively coupled to an associated seasoning auger of the plurality of seasoning augers.

8. The modular cooking system of claim 7, wherein the seasoning dispenser module further comprises:
a dispensing tube coupled to the plurality of seasoning tubes opposite the plurality of seasoning containers, the dispensing tube being in fluid communication with the plurality of seasoning tubes, the dispensing tube extending vertically with respect to the main body, the dispensing tube defining an outlet at a bottom end of the dispensing tube;
a dispensing auger mounted in and extending along the dispensing tube; and
a dispensing auger motor operatively coupled to the dispensing auger.

9. The modular cooking system of claim 8, wherein the seasoning dispenser module further comprises a screen mounted in the dispensing tube adjacent to the outlet, the screen defining a plurality of apertures which extend therethrough.

10. The modular cooking system of claim 7, wherein:
each seasoning container of the plurality of seasoning containers of the seasoning dispenser module comprises a perimeter wall and a funnel, the funnel being coupled to and extending downwardly from the perimeter wall; and
each seasoning tube of the plurality of seasoning tubes of the seasoning dispenser module is coupled to an outlet end of the funnel of the associated seasoning container.

11. The modular cooking system of claim 5, wherein:
the food preparation compartment further comprises a chopping section, the chopping section being in fluid communication with the food loading section; and
further comprising a chopping module mounted in the chopping section of the food preparation compartment, the chopping module being configured to cut the food item when the food item is positioned in the chopping section of the food preparation compartment.

12. The modular cooking system of claim 11, wherein the chopping module comprises:
a support frame mounted to the main body;
a first chopping member mounted to the support frame, the first chopping member comprising a plurality of first blades, the first chopping member being movable alternately upwardly and downwardly with respect to the main body, each first blade of the plurality of first blades having a first cutting edge facing downwardly with respect to the main body; and
a first chopping drive operatively coupled to the first chopping member.

13. The modular cooking system of claim 12, wherein the chopping module further comprises:
a second chopping member mounted to the support frame, the second chopping member comprising a plurality of second blades, the second chopping member being movable alternately upwardly and downwardly with respect to the main body, each second blade of the plurality of second blades having a second cutting edge facing downwardly with respect to the main body; and
a second chopping drive operatively coupled to the second chopping member.

14. The modular cooking system of claim 13, wherein:
each first blade of the plurality of first blades of the chopping module extends laterally with respect to the main body, the plurality of first blades being evenly spaced from each other, the plurality of first blades being oriented parallel to each other; and
each second blade of the plurality of second blades of the chopping module extends forwardly and rearwardly with respect to the main body, the plurality of second blades being evenly spaced from each other, the plurality of second blades being oriented parallel to each other.

15. The modular cooking system of claim 13, wherein:
the first chopping drive of the chopping module comprises a first chopping motor and a pair of first lever arms, the first lever arms being coupled to and extending outwardly from an output shaft of the first chopping motor, the first chopping member pivotably coupled to and hanging from the pair of first lever arms opposite the output shaft of the first chopping motor; and
the second chopping drive of the chopping module comprises a second chopping motor and a pair of second lever arms, the second lever arms being coupled to and extending outwardly from an output shaft of the second chopping motor, the second chopping member pivotably coupled to and hanging from the pair of second lever arms opposite the output shaft of the second chopping motor.

16. The modular cooking system of claim 5, wherein the food conveying module comprises:
a robotic arm mounted in the conveying space of the main body, the robotic arm being configured to move the food item; and
a gantry mounted in the conveying space of the main body, the gantry being configured to move the robotic arm vertically and laterally with respect to the main body.

17. The modular cooking system of claim 16, wherein:
the robotic arm of the food conveying module comprises:
a base;
an arm segment, the arm segment being pivotably coupled to the base, the arm segment being movable alternately forward and rearward of the base with respect to the main body, the arm segment defining a notch in a distal end thereof with respect to the main body, the notch being configured to receive a tray holding the food item; and
a linear actuator coupled to and extending between the base and the arm segment, the linear actuator being operable to pivot the robotic arm with respect to the base; and
the gantry of the food conveying module comprises:
a horizontal rail mounted to the main body and extending laterally through the conveying space;
a vertical rail movably mounted onto the horizontal rail, the base of the robotic arm being movably mounted to the vertical rail;
a horizontal drive mounted to the vertical rail, the horizontal drive being engaged with the horizontal rail to move the vertical rail along the pair of horizontal rails, the horizontal drive comprising a horizontal motor and a horizontal drive wheel, the horizontal motor being operatively coupled to the horizontal drive wheel, the horizontal drive wheel being movably mounted on the horizontal rail; and
a vertical drive mounted to the base of the robotic arm, the vertical drive comprising a vertical motor and a vertical drive wheel, the vertical motor being operatively coupled to the vertical drive wheel, the vertical drive wheel being movably mounted on the vertical rail.

18. The modular cooking system of claim 1, further comprising:
a processor being operatively coupled to a selected front cooking module of the plurality of front cooking modules when the selected front cooking module is inserted into the associated bay;
a main control interface mounted to the main body and operatively coupled to the processor;
a main display mounted to the main body and operably coupled to the processor; and
a transceiver operably coupled to the processor, the processor being configured to communicate with a remote electronic device via the transceiver.

19. The modular cooking system of claim 1, wherein:
the main body defines a recess in a top side of the body; and
further comprising:
a plurality of cooktop modules, each cooktop module of the plurality of cooktop modules being positionable in the recess of the main body, each cooktop module of the plurality of cooktop modules being configured to perform an associated cooktop cooking function.

20. A modular cooking system comprising:
a main body which defines a plurality of bays, each bay of the plurality of bays being open on a front side of the main body, the main body defining a food preparation compartment therein, the food preparation compartment being separated from the plurality of bays, the food preparation compartment including a food loading section, a seasoning section, and a chopping section, the food loading section being positioned between and in fluid communication with the seasoning section and the chopping section, the main body defining a conveying space positioned between the plurality of bays and a back side of the main body, the conveying space being positioned between the food preparation compartment and the back side of the main body, the main body defining a recess in a top side of the body;
a plurality of front cooking modules, each front cooking module of the plurality of front cooking modules being receivable into an associated bay of the plurality of bays, each front cooking module of the plurality of front cooking modules being configured to perform an associated cooking function, each front cooking module of the plurality of front cooking modules comprising:
an enclosure defining an interior volume therein, the enclosure being complementary in shape to the associated bay of the plurality of bays;
a front door mounted on a front wall of the enclosure, the front door being movable to selectively access the interior volume of the enclosure from outside the enclosure;
a rear door mounted on a rear wall of the enclosure, the rear door being movable to selectively access the interior volume of the enclosure from outside the enclosure;
a front module control interface mounted on the front wall of the enclosure, the front module control interface being configured to operate the front cooking module;
a front module display mounted on the front wall of the enclosure; and
a set of front module electrical contacts mounted to an exterior of the enclosure;
a food loading door mounted to the front side of the main body, the food loading door being movable to selectively access the food loading section of the food preparation compartment;
a seasoning dispenser module mounted in the seasoning section of the food preparation compartment, the seasoning dispenser module being removable from the food preparation compartment through the front side of the main body, the seasoning dispenser module comprising:
a plurality of seasoning containers, each seasoning container of the plurality of seasoning containers defining an interior space therein, each seasoning container of the plurality of seasoning containers comprising a perimeter wall and a funnel, the funnel being coupled to and extending downwardly from the perimeter wall;
a plurality of seasoning tubes, each seasoning tube of the plurality of seasoning tubes being in fluid communication with an associated seasoning container of the plurality of seasoning containers, each seasoning tube of the plurality of seasoning tubes being coupled to an outlet end of the funnel of the associated seasoning container;
a plurality of seasoning augers, each seasoning auger of the plurality of seasoning augers being positioned in an associated seasoning tube of the plurality of seasoning tubes, each seasoning auger of the plurality of seasoning augers extending along the associated seasoning tube;
a plurality of seasoning auger motors, each seasoning auger motor of the plurality of seasoning auger motors being operatively coupled to an associated seasoning auger of the plurality of seasoning augers;
a dispensing tube coupled to the plurality of seasoning tubes opposite the plurality of seasoning containers, the dispensing tube being in fluid communication with the plurality of seasoning tubes, the dispensing tube extending vertically with respect to the main body, the dispensing tube defining an outlet at a bottom end of the dispensing tube;
a dispensing auger mounted in and extending along the dispensing tube;
a dispensing auger motor operatively coupled to the dispensing auger; and
a screen mounted in the dispensing tube adjacent to the outlet, the screen defining a plurality of apertures which extend therethrough;
a chopping module mounted in the chopping section of the food preparation compartment, the chopping module comprising:
a support frame mounted to the main body;
a first chopping member mounted to the support frame, the first chopping member comprising a plurality of first blades, the first chopping member being movable alternately upwardly and downwardly with respect to the main body, each first blade of the plurality of first blades having a first cutting edge facing downwardly with respect to the main body, each first blade of the plurality of first blades extending laterally with respect to the main body, the plurality of first blades being evenly spaced from each other, the plurality of first blades being oriented parallel to each other;
a second chopping member mounted to the support frame, the second chopping member comprising a plurality of second blades, the second chopping member being movable alternately upwardly and downwardly with respect to the main body, each second blade of the plurality of second blades having a second cutting edge facing downwardly with respect to the main body, each second blade of the plurality of second blades extending forwardly and rearwardly with respect to the main body, the plurality of second blades being evenly spaced from each other, the plurality of second blades being oriented parallel to each other;
a first chopping drive operatively coupled to the first chopping member, the first chopping drive comprising a first chopping motor and a pair of first lever arms, the first lever arms being coupled to and extending outwardly from an output shaft of the first chopping motor, the first chopping member pivotably coupled to and hanging from the pair of first lever arms opposite the output shaft of the first chopping motor; and
a second chopping drive operatively coupled to the second chopping member, the second chopping drive comprising a second chopping motor and a pair of second lever arms, the second lever arms being coupled to and extending outwardly from an output shaft of the second chopping motor, the second chopping member pivotably coupled to and hanging from the pair of second lever arms opposite the output shaft of the second chopping motor;
a plurality of food preparation access doors mounted to the main body between the food preparation compartment and the conveying space, each food preparation access door of the plurality of food preparation access doors being movable to selectively access the food preparation compartment from the conveying space, each food preparation access door of the plurality of food preparation access doors being positioned adjacent to a respective one of the food loading section, the seasoning section, and the chopping section;
a food conveying module mounted in the main body, the food conveying module being configured to move a food item among the plurality of bays of the main body and the food loading section, the seasoning section, and the chopping section of the food preparation compartment of the main body, the food conveying module comprising:
a robotic arm mounted in the conveying space of the main body, the robotic arm comprising:
a base;
an arm segment, the arm segment being pivotably coupled to the base, the arm segment being movable alternately forward and rearward of the base with respect to the main body, the arm segment defining a notch in a distal end thereof with respect to the main body, the notch being configured to receive a tray holding the food item; and
a linear actuator coupled to and extending between the base and the arm segment, the linear actuator being operable to pivot the robotic arm with respect to the base; and
a gantry mounted in the conveying space of the main body, the gantry being configured to move the robotic arm vertically and laterally with respect to the main body, the gantry comprising:
a pair of horizontal rails mounted to the main body and extending laterally through the conveying space, the pair of horizontal rails being spaced from each other vertically with respect to the main body;
a vertical rail movably mounted onto the pair of horizontal rails, the base of the robotic arm being movably mounted to the vertical rail;
a pair of horizontal drives mounted to the vertical rail, each horizontal drive of the pair of horizontal drives being engaged with a respective horizontal rail of the pair of horizontal rails to move the vertical rail along the pair of horizontal rails, each horizontal drive of the pair of horizontal drives comprising a horizontal motor and a horizontal drive wheel, the horizontal motor being operatively coupled to the horizontal drive wheel, the horizontal drive wheel of each horizontal drive being movably mounted on the respective horizontal rail; and
a vertical drive mounted to the base of the robotic arm, the vertical drive comprising a pair of vertical motors and a pair of vertical drive wheels, each vertical motor of the pair of vertical motors being operatively coupled to a respective vertical drive wheel of the pair of vertical drive wheels, the pair of vertical drive wheels being movably mounted on the vertical rail;
a processor mounted in the main body, the processor being operatively coupled to the seasoning dispenser module, the chopping module, and the food conveying module;
a plurality of bay electrical contacts, each bay electrical contact being mounted in an associated bay of the plurality of bays, each bay electrical contact being positioned such that the processor is electrically coupled to a selected front cooking module of the plurality of front cooking modules when the selected front cooking module is inserted into the associated bay;
a main control interface mounted to the main body and operatively coupled to the processor;
a main display mounted to the main body and operably coupled to the processor;
a plurality of top electrical contacts mounted in the recess of the main body;
a plurality of cooktop modules, each cooktop module of the plurality of cooktop modules being positionable in the recess of the main body, each cooktop module of the plurality of cooktop modules being configured to perform an associated cooktop cooking function, each cooktop module of the plurality of cooktop modules comprising a pair of cooktop electrical contacts, the pair of cooktop electrical contacts being positioned to electrically couple the cooktop module to the processor via an associated pair of top electrical contacts of the plurality of top electrical contacts; and
a transceiver operably coupled to the processor, the processor being configured to communicate with a remote electronic device via the transceiver.
